(19) United States
(12) Patent Application Publication
(10) Pub. No.: US 2009/0288826 A1
(43) Pub. Date: Nov. 26, 2009

(54) Enzyme enhanced oil recovery (EEOR) for cyclic steam injection

(76) Inventor: John L. Gray, Houston, TX (US)

Correspondence Address: GUERRY LEONARD GRUNE, 784 S VILLIER CT., VIRGINIA BEACH, VA, 23452, US

(21) Appl. No.: 12/460,825

(22) Filed: Jul. 24, 2009

Related U.S. Application Data
(63) Continuation of application No. 11/708,238, filed on Feb. 20, 2007.
Application No. 11/708,238 is a continuation of application No. 11/601,921, filed on Nov. 20, 2006, now abandoned.

(51) Int. Cl. E21B 43/22; E21B 43/16; E21B 43/24; E21B 36/00; C09K 8/62

(52) U.S. Cl. 166/263; 166/90.1; 507/201

(57) ABSTRACT

The present disclosure relates to the release or recovery of subterranean hydrocarbon deposits and, more specifically, to a system for enhanced oil recovery (EOR), by utilizing stabilized enzymatic fluid and cyclic injection of steam or heated fluid into subterranean formations.

### CLAIM TO PRIORITY

This application is a continuation of application Ser. No. 11/601,921, now abandoned, which claims priority under all rights to which they are entitled under 35 U.S.C. Section 120 filed Nov. 20, 2006 entitled “ENZYME ENHANCED OIL RECOVERY (EEOR) FOR CYCLIC STEAM INJECTION”.

### FIELD OF INVENTION

The present disclosure relates to the release or recovery of subterranean hydrocarbon deposits and, more specifically, to a system for enhanced oil recovery (EOR), by utilizing enzyme compositions and cyclic injection of steam or heated fluid into subterranean formations.

### BACKGROUND OF INVENTION

It is a common practice to treat production wells and other subterranean formations with various methodologies in order to increase petroleum, gas, oil or other hydrocarbon production using enhanced (secondary or tertiary) oil recovery. Enhanced oil recovery processes include cyclic steam, steamflood, Water-Alternating-Gas (WAG), in-situ combustion, the addition of micellar-polymer flooding, and microbial solutions.

### DEFINITIONS

One common practice is to treat viscous crude in subterranean formations using cyclic steam to increase overall recovery of original oil in place (OOIP) in wells or hydrocarbon zones that otherwise have low recovery rates. A cyclic steam-injection process includes three stages. The first stage is injection, during which a slug of steam is introduced into the reservoir. The second stage, or soak period, requires that the well be shut in for several days to allow uniform heat distribution to thin the oil. Finally, during the third stage, the thinned oil is produced through the same well. The cycle is repeated as long as oil production is profitable.

Cyclic steam injection is used extensively in heavy-oil reservoirs, tar sands, and in some cases to improve injectivity prior to steamflood or in-situ combustion operations.

Cyclic steam injection is also called steam soak or the huff ‘n’ puff (slang) method. Steamflooding is a method of thermal recovery in which steam generated at the surface is injected into the reservoir through specially distributed injection wells.

When steam enters the reservoir, it heats up the crude oil and reduces its viscosity. The heat also distills light components of the crude oil, which condense in the oil bank ahead of the steam front, further reducing the oil viscosity. The hot water that condenses from the steam and the steam itself generate an artificial drive that sweeps oil toward producing wells.

Another contributing factor that enhances oil production during steam injection is related to near-wellbore cleanup. In this case, steam reduces the interfacial tension that ties paraffins and asphaltenes to the rock surfaces while steam distillation of crude oil light ends creates a small solvent bank that can miscibly remove trapped oil.

Steamflooding is also known as continuous steam injection or steam drive.

Water alternating gas is an enhanced oil recovery process whereby water injection and gas injection are alternately injected for periods of time to provide better sweep efficiency and reduce gas channeling from injector to producer. This process is used mostly in CO₂ floods to improve hydrocarbon contact time and sweep efficiency of the CO₂.

In-situ combustion is a method of thermal recovery in which fire is generated inside the reservoir by injecting a gas containing oxygen, such as air. A special heater in the well ignites the oil in the reservoir and starts a fire.

The heat generated by burning the heavy hydrocarbons in place produces hydrocarbon cracking, vaporization of light hydrocarbons and reservoir water in addition to the deposition of heavier hydrocarbons known as coke. As the fire moves, the burning front pushes ahead a mixture of hot combustion gases, steam and hot water, which in turn reduces oil viscosity and displaces oil toward production wells.

Additionally, the light hydrocarbons and the steam move ahead of the burning front, condensing into liquids, which adds the advantages of miscible displacement and hot waterflooding.

In-situ combustion is also known as fire flooding or fireflood.

Other types of in-situ combustion are dry combustion, dry forward combustion, reverse combustion and wet combustion which is a combination of forward combustion and waterflooding.

Micelles are a group of round hydrocarbon chains formed when the surfactant concentration in an aqueous solution reaches a critical point. The micellar costs depend upon the cost of oil, since many of these chemicals are petroleum sulfonates.

Micellar-polymer flooding is an enhanced oil recovery technique in which a micelle solution is pumped into a reservoir through specially distributed injection wells. The chemical solution reduces the interfacial and capillary forces between oil and water and triggers an increase in oil production.

The procedure of a micellar-polymer flooding includes a preflush (low-salinity water), a chemical solution (micellar or alkaline), a mobility buffer and, finally, a driving fluid (water), which displaces the chemicals and the resulting oil bank to production wells.

In the previously defined methods for enhanced oil recovery (EOR) all still leave residual hydrocarbons in the well. In some EOR, processes are combined to compensate for inefficiencies in one of more of the methods.

Hydraulic fracturing is accomplished by injecting a hydraulic fracturing fluid into the well and imposing sufficient pressure on the fracture fluid to cause formation breakdown with the attendant production of one or more fractures. Usually a gel, an emulsion or a foam, having a proppant, such as sand or other suspended particulate material, is introduced into the fracture. The proppant is deposited in the fracture and functions to hold the fracture open after the pressure is released and fracturing fluid is withdrawn back into the well. The fracturing fluid has a sufficiently high viscosity to penetrate into the formation and to retain the proppant in suspension or at least to reduce the tendency of the proppant of settling out of the fracturing fluid. Generally, a gelation agent and/or an emulsifier is used in the fracturing fluid to provide the high viscosity needed to achieve maximum benefits from the fracturing process.

After the high viscosity fracturing fluid has been pumped into the formation and the fracturing has been completed, it is, of course, desirable to remove the fluid from the formation to allow hydrocarbon production through the new fractures. The removal of the highly viscous fracturing fluid is achieved by “breaking” the gel or emulsion or by converting the fracturing fluid into a low viscosity fluid. The act of breaking a gelled or emulsified fracturing fluid has commonly been obtained by adding “breaker”, that is, a viscosity-reducing agent, to the subterranean formation at the desired time. This technique can be unreliable sometimes resulting in incomplete breaking of the fluid and/or premature breaking of the fluid before the process is complete reducing the potential amount of hydrocarbon recovery. Further, it is known in the art that most fracturing fluids will “break” if given enough time and sufficient temperature and pressure.

Several proposed methods for the breaking of fracturing fluids are aimed at eliminating the above problems such as introducing an encapsulated percarbonate, perchlorate, or persulfate breaker into a subterranean formation being treated with the fracturing fluid. Various chemical agents such as oxidants, i.e., perchlorates, percarbonates and persulfates not only degrade the polymers of interest but also oxidize tubulars, equipment, etc. that they come into contact with, including the formation itself. In addition, oxidants also interact with resin coated proppants and, at higher temperatures, they interact with gel stabilizers used to stabilize the fracturing fluids which tend to be antioxidants. Also, the use of oxidants as breakers is disadvantageous from the point of view that the oxidants are not selective in degrading a particular polymer. In addition, chemical breakers are consumed stoichiometrically resulting in inconsistent gel breaking and some residual viscosity which causes formation damage.

The use of enzymes to break fracturing fluids may eliminate some of the problems relating to the use of oxidants. For example, enzyme breakers are very selective in degrading specific polymers. The enzymes do not effect the tubulars, equipment, etc. that they come in contact with and/or damage the formation itself. The enzymes also do not interact with the resin coated proppants commonly used in fracturing systems. Enzymes react catalytically such that one molecule of enzyme may hydrolyze up to one hundred thousand (100,000) polymer chain bonds resulting in a cleaner more consistent break and very low residual viscosity. Consequently, formation damage is greatly decreased. Also, unlike oxidants, enzymes do not interact with gel stabilizers used to stabilize the fracturing fluids.

It has been discussed previously that there are several methods of recovering oil from a well, however, there is no art disclosed where an enzyme has been used either as a pre-treatment for an oil reservoir or as an additive within a steam cycle for secondary or tertiary oil recovery.

Therefore, there exists a need for a method of injecting an enzyme composition used in conjunction with cyclic steam injection having a wide temperature range for activity and with additional subterranean liquid phase temperature stability under pressure. The disclosure of the present application provides several methods for injecting an enzyme composition as a pretreatment for hydrocarbon deposits, that is not a breaker for the dissolution of polymeric viscosifiers, but has the catalytic ability to release oil from solid surfaces while reducing surface tension and improving mobility associated with the crude oil flow.

### DESCRIPTION OF PRIOR ART

U.S. Pat. No. 5,881,813 to Brannon, et. al., and assigned to BJ Services Company, describes a method for improving the effectiveness of a well treatment in subterranean formations comprising the steps of injecting a clean-up fluid into the well wherein the clean-up fluid contains one or more enzymes in an amount sufficient to degrade polymeric viscosifiers and contacting the wellbore and formation with the clean-up fluid for a period of time sufficient to degrade polymeric viscosifiers therein and performing a treatment to remove non-polymer solids that may be present; and removing the non-polymer solids in the well to improve productivity or injectivity of the subterranean formation.

U.S. Pat. No. 5,247,995 to Tjon-Joe-Pin, et. al., and assigned to BJ Services Company, describes a method of increasing the flow of production fluids from a subterranean formation by removing a polysaccharide-containing filter cake formed during production operations and found within the subterranean formation which surrounds a completed well bore comprising the steps of allowing production fluids to flow from the well bore, a reduction in the flow of production fluids from the formation below expected flow rates, formulating an enzyme treatment by blending together an aqueous fluid and enzymes, pumping the enzyme treatment to a desired location within the well bore and allowing the enzyme treatment to degrade the polysaccharide-containing filter cake, whereby the filter cake can be removed from the subterranean formation to the well surface.

U.S. Pat. No. 4,682,654 to Carter, et. al., and assigned to Millmaster Onyx Group, Inc., describes a method of recovering oil from an oil bearing formation by fracturing including the step of inserting into the formation at high pressure an aqueous composition comprising guar gum in water with the guar gum having been first coated and impregnated while in the solid particulate state with an aqueous solution of a hydrolytic enzyme.

U.S. Pat. No. 5,604,186 to Hunt, et. al., and assigned to Haliburton Co., describes a method of breaking an aqueous fracturing fluid comprising introducing the aqueous fracturing fluid into contact with an encapsulated enzyme breaker. The enzyme breaker comprises a particulate cellulose substrate having a particle size in the range of from about 10 to 50 mesh, an enzyme solution coated upon the substrate, with the enzyme solution including a first micron-sized insert particulate having a particle size below about 15 microns and present in an amount of from about 1 to about 15 percent by weight of the enzyme solution and a membrane encapsulating the enzyme solution and substrate. The membrane comprises a partially hydrolyzed acrylic cross-linked with either an aziridine prepolymer or a carbodimide and having imperfections through which an aqueous fluid can diffuse to contact the enzyme and subsequently diffuse outward from the breaker with the enzyme to contact and break the fracturing fluid.

U.S. Pat. No. 5,441,109 to Gupta, et. al., and assigned to The Western Company of North America, describes a method of fracturing a subterranean formation which surrounds a well bore comprising the steps of injecting a fracturing fluid under pressure into the well bore, injecting an enzyme breaker having activity only above a selected temperature, the selected temperature being at least equal to or greater than 100° F., maintaining the fluid in the well bore under sufficient pressure to fracture the formation and breaking the fluid with the breaker.

U.S. Pat. No. 5,226,479 to Gupta, et. al., and assigned to The Western Company of North America, describes a method of fracturing a subterranean formation comprised of injecting a fracturing fluid and a breaker system into a formation to be fractured, with the breaker system comprised of an enzyme component and γ-butyrolactone and supplying sufficient pressure on the formation for a sufficient period of time to fracture the formation. After fracturing the pH of the fluid with γ-butyrolactone is adjusted whereby the enzyme component becomes active and capable breaking the fluid with the enzyme component and subsequently releasing the pressure on the formation.

U.S. Pat. No. 4,996,153 to Cadmus, et. al., and assigned to the USA Dept of Agriculture, describes a heat stable, salt-tolerant xanthanase contained in, or recovered from, a fermentation broth of a culture of NRRL B-18445 and characterized by the property of retaining approximately 100% of its original activity upon being heated at 55° C. for 20 minutes.

U.S. Pat. No. 4,886,746 to Cadmus, et. al., and assigned to the USA Dept of Agriculture, describes a mixed bacterial culture having the identifying characteristics of ARS Culture Collection Accession No. NRRL B-18445; said culture being capable of producing xanthanase enzymes which are functional up to 65° C.

U.S. Pat. No. 3,684,710 to Cayle, et. al., and assigned to Baxter Laboratories, describes a dry enzyme composition having improved pH stability and pH activity characteristics in aqueous solution consisting essentially of galactomannan polymer in combination with mannan depolymerase enzyme components. The enzyme components are derived from two different species of microorganisms.

U.S. Pat. No. 4,641,710 to Klinger, Barry, and assigned to Applied Energy, Inc., describes a method of removing deposits releasable a substance in a vapor phase from a subterranean area below a surficial formation comprising in combination the steps of: providing a hole through the surficial formation to the subterranean formation; storing the substance at the surficial formation in the form of a liquid convertible at the subterranean formation to a vapor phase; providing a heating fluid heatable at a surface of the surficial formation remote from the subterranean formation to a temperature sufficient for a conversion of the liquid to a vapor phase. at said subterranean formation by a transfer of heat from said heating fluid to said liquid; Heating of the heating fluid at the surface of the surficial formation, remote from the subterranean formation, to a heated state providing a sufficient temperature and circulating the heating fluid in the hole in a closed circuit extending the heated fluid to the subterranean formation and then back to the surface for repeated reheating. The heated state provides sufficient temperature and for recirculation of the heating fluid at the heated state to the subterranean formation. The convertible liquid is advanced to the subterranean formation at the hole applying heat from the recirculating heating fluid in the hole to the liquid. The liquid is converted into a vapor by the application of heat from the recirculating heating fluid in the hole, but preserving the heating fluid against combustion and chemical reaction during the heating, circulation, reheating and recirculation. During the application of heat to, and conversion to, the vapor phase of the liquid and preserving the heating fluid against escape into the subterranean formation drives the vapor into the subterranean formation for releasing the deposits with the vapor and removes the released deposits from the subterranean formation.

U.S. Pat. No. 4,175,618 to Wu, et. al., and assigned to Texaco Inc., describes a method of recovering viscous petroleum from a subterranean, viscous petroleum-containing, permeable formation penetrated by at least one injection well and by at least one production well, in fluid communication with the formation, comprising injecting a thermal recovery fluid comprising steam into the formation and producing fluids from the formation via the production well for a predetermined period of time, thereby forming a steam-swept zone in the formation. The second step involves injecting an emulsifying fluid into the steam-swept zone with the emulsifying fluid comprising water having dissolved therein a surfactant capable of forming a viscous emulsion with formation petroleum at the temperature and water salinity present in the steam-swept zone. The water, containing the emulsifying surfactant, forms a viscous emulsion in the steam-swept zone with residual petroleum present in that zone, thereby decreasing the permeability of that zone with the surfactant comprising an organic sulfonate selected from the group consisting of petroleum sulfonate having a median equivalent weight from 325 to 475, and synthetic sulfonates of the formula RSO3 X wherein R is an alkyl, linear or branched, having from 8 to 24 carbon atoms or an alkylaryl including benzene or toluene having attached thereto at least one alkyl group, linear or branched, and containing from 6 to 18 carbon atoms in the alkyl chain, and X is sodium, potassium, lithium or ammonium. The third step is injecting steam into the formation well via the injection well and recovering fluids including petroleum from the formation via the producing well.

U.S. Pat. No. 3,802,508 to Kelly, et. al., and assigned to Marathon Oil Co., describes a process of recovering hydrocarbon from sub-surface tar sands having at least one injection means in fluid communication with at least one production means and comprising heating the tar sands to a temperature sufficient to heat an incoming water-external micellar to a temperature above about 100° F. by the time the micellar dispersion travels about 7.5 to about 15 feet into the tar sands. The water-external micellar dispersion is injected into the tar sands displacing the micellar dispersion toward the production means and recovering hydrocarbon through the production means.

U.S. Pat. No. 3,800,873 to Kelly, et. al., and assigned to Marathon Oil Co., describes a process of recovering hydrocarbon from sub-surface tar sands having at least one injection means in fluid communication with at least one production means comprising heating the tar sands to a temperature sufficient to heat an incoming oil-external micellar dispersion to a temperature above about 100° F. by the time the micellar dispersion travels about 7.5 to about 15 feet into the tar sands. The oil-external micellar dispersion is injected into the tar sands displacing the micellar dispersion toward at least one of the production means and recovering hydrocarbon through the production means.

U.S. Pat. No. 5,879,107 to Kriest, et. al., and assigned to Biomanagement Services Inc., describes a process for treating a zone of underground hydrocarbon contamination, above a certain acceptable level of contamination, comprising the steps of providing a fluid that aids in the degradation of petroleum or chemical hydrocarbons; providing the fluid under pressure to create, by fluid jetting a substantially vertical path through the zone to saturate with the fluid and a core extending vertically through the zone and horizontally outward from the path and repeating steps at other locations to form a series of overlapping cores that substantially includes all of the zone. Additionally the degradation is allowed to occur, thereafter testing to determine the degree of contamination remaining and, if above the acceptable level, repeating steps all the steps until the contamination is reduced to below the acceptable level.

U.S. Pat. No. 5,020,595 to Van Slyke, Donald, and assigned to Union Oil Co., describes a process for reducing corrosion of well tubing while recovering oil from an oil-bearing formation using a carbon dioxide-steam co-injection method, the process comprising the steps of: heating feedwater to generate steam; injecting a carbonate-containing pH adjusting agent into the steam to form a pH adjusting agent-containing steam; injecting carbon dioxide into the pH adjusting agent-containing steam to form an enhanced oil recovery composition having a pH of about 6.3 to less than 7.5; injecting the enhanced oil recovery composition into at least a portion of an oil-bearing formation and withdrawing oil from the formation.

U.S. Pat. No. 4,743,385 to Angstadt, et. al., and assigned to Sun Refining and Marketing Co., describes an improved method for the enhanced recovery of oil from subterranean formations whereby steam is injected into the formations, the improvement comprising incorporating in the steam an effective amount of a mixture comprising about a 1:0.05-0.5:2.0 weight ratio of a C14-20 alkyl toluene sulfonate, a C14-20 ethylbenzene sulfonate, or a C14-20 alkyl benzene sulfonate and a hydrotrope selected from the group consisting of alkali metal xylene sulfonates, alkali metal toluene sulfonates, alkali metal cumene sulfonates, alkali metal benzene sulfonates, alkali metal isethionates, alkali metal butane sulfonates and alkali metal hexane sulfonates.

### SUMMARY OF THE DISCLOSURE

One embodiment of the disclosure includes a method and system of removing petroleum, oil and other hydrocarbon deposits releasable by a substance from a subterranean formation below a surficial formation. The method and system according to this disclosure comprises, in combination, the steps of providing a hole through the surficial formation to the subterranean formation, injecting an enzyme through the surficial formation to the subterranean formation, storing the substance at the surficial formation in the form of a liquid at the subterranean formation. Also, for steam injection, providing a heating fluid heatable at either the surface or at the surficial formation remote from the subterranean formation to a temperature sufficient for sustained liquid phase of stabilized aqueous enzyme solutions under pressure at the subterranean formation. The ability to drive the liquid into the subterranean formation for releasing hydrocarbon deposits with that liquid, and removing such released deposits from the subterranean formation is also part of the present disclosure.

Another embodiment of the disclosure is a method and system for injecting an enzyme composition into a well as a treatment for enhanced oil recovery (EOR) within a steam cycle including a process sometimes referred to as cyclic steam stimulation (CSS).

Another embodiment of the disclosure is the use of a stabilized aqueous enzyme solution made in a batch fermentation process as the enzyme composition for treatment of an oil well.

Another embodiment is the use of an enzyme composition for pre-treatment and treatment between steam injection cycles or treatment of the well during the steam injection cycle where the enzyme is injected as a heated liquid into the well.

Another embodiment is the use of an enzyme diluted in water within a working range of 0.5 to 10 percent of said enzymatic fluid in water.

Another embodiment is the use of incrementally diluted enzyme to stimulate wells that are at an unacceptable level of production prior to restarting a cyclic steam injection process.

Another embodiment is the use an enzyme composition for pre-treatment or treatment of the well during EOR where an enzyme is injected intermixed with water into the well and the well is shut down for a period of time ranging from on or about 3-5 days to about 30+ days. In California, the injected steam volume is of the order of 10,000 barrels per cycle injected over about 2 weeks. In Cold Lake, Alberta, with oil viscosities that are 10-20 times higher than California, steam injection volumes are larger—perhaps 30,000 barrels per cycle injected over a month.

Another embodiment is the use of an enzyme composition used to be injected into pipelines to clean plugged or restricted flow areas and to prevent heavy crude oil from plugging the pipelines.

Another embodiment is the use of an enzyme composition for reducing asphaltenes and waxes at the injection wellbore prior to steam injection as well as minimizing wellbore build up during production and at the end of the cycle.

Another embodiment is the use of an enzyme in cyclic steam operations such that the enzyme does not affect the normal heat transfer provided by the steam into the surrounding well formations or the oil.

Another embodiment is the use of enzymatic fluid in cyclic steam operations so that the reduction of steamload is accomplished to recover oil and impart a favorable impact to the steam-to-oil ratio (SOR).

Another embodiment is the use of enzymatic fluid in cyclic steam operations so that increased oil production is achieved for the same steamload which imparts a favorable impact to the steam-to-oil ratio (SOR).

### BRIEF DESCRIPTION OF THE DRAWINGS

FIG. 1 is a schematic for cyclic steam injection stages with a pretreatment stage using stabilized aqueous enzyme fluid.

### DETAILED DESCRIPTION

Disclosed is an improvement to cyclic steam stimulation (CSS) processes for secondary and/or tertiary oil recovery that utilizes an enzyme composition. In particular is a stabilized aqueous enzyme solutions made in a batch fermentation process. This biological enzyme is a protein based, non-living catalyst for penetrating and releasing oil from solid surfaces. It demonstrates the following attributes:

Enzyme fluid has the effect of increasing the mobility of the oil by reducing surface tension and preventing crude oil that has become less viscous by heating or other means, from re-adhering to itself as it cools.
Enzyme fluid is active in water and acts catalytically in contacting and releasing oil from solid surfaces.
Enzyme fluid is not based on live microbes and does not require nutrients or ingest oil.
Enzyme fluid does not grow or plug an oil formation or release cross-linked polymers.

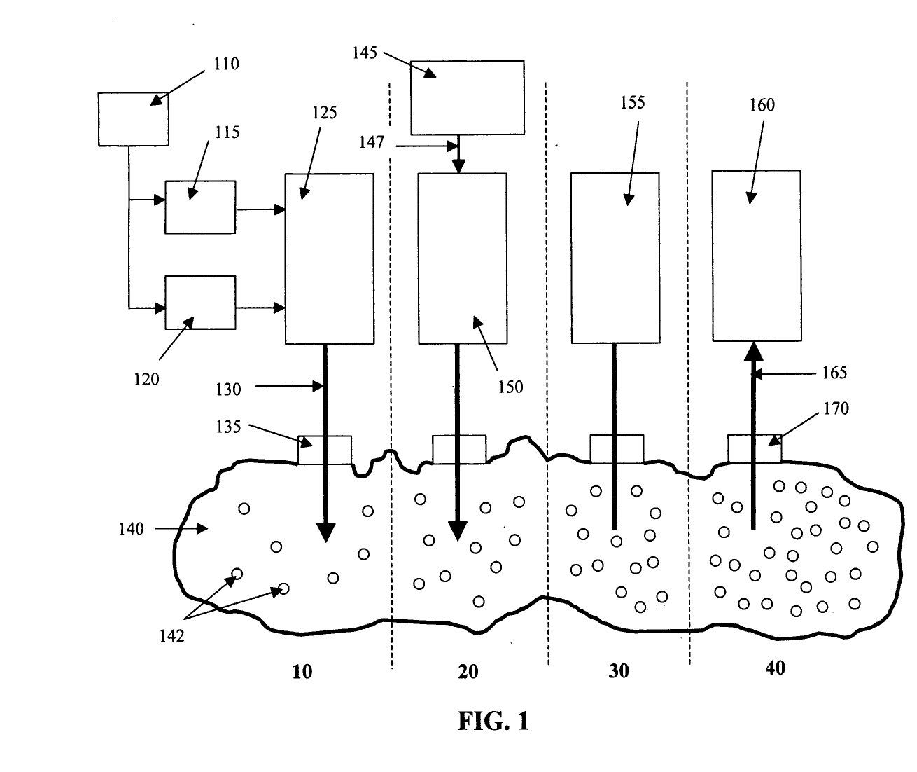

Referring to FIG. 1, in an overview, the cyclic steam and enzyme system is comprised of four (4) stages. The first stage is pre-treatment [10] followed by a steam injection stage [20], a period of idle process known as the soak stage [30] followed by the recovery stage [40]. This cyclic steam and enzyme system [10] is sequential and repeated whenever recovery volumes diminish to a calculated economic break-even point.

In the stage of pre-treatment [10], a stabilized aqueous enzyme solution [110] and described above, is diluted to become a diluted enzymatic fluid [115] and sent to a heater [120] to have the temperature of the diluted enzymatic fluid [115] optionally pre-heated. The heated diluted enzymatic fluid [122] is then transferred to an enzyme pump [125]. Alternatively, diluted enzymatic fluid [115] may be transferred directly to the enzyme pump [125] bypassing the heater [120]. A sufficient volume of the diluted enzymatic fluid [115] or heated diluted enzymatic fluid [122] is then pumped through an injection pipe [130] through the downhole well bore [125] and into the oil well formation [140] so as to contact a desirable amount of residual oil particles [142]. The stage of pre-treatment [10] may last from 0-5 days before commencing the steam injection stage [30]. During the stage of pre-treatment [10] the diluted enzyme fluid [115] or heated diluted enzymatic fluid [122] acts to release the oil from solid surfaces, increase the mobility of the oil by reducing surface tension, preventing crude oil that has become less viscous by heating or other means, from re-adhering to itself as it cools and acts catalytically in contacting and releasing oil from solid surfaces. Blockages in the oil well formation [140] may be reduced or eliminated as well.

In the steam injection stage [30], a steam generator [145] combines heat and water to form steam [147]. Steam [147] is then transferred to a steam/vapor pump [150] where it is then pumped down an injection pipe [130], which may be the same as or different from the one used by the enzyme pump [125], through the downhole well bore [135] and into the oil well formation [140]. Steam [147] then loses its heat into the oil well formation [140] warming the oil particles [142] and the surrounding area oil well formation [140] to a sufficient temperature to cause the oil particles [142] to become less viscous. The steam [147] also acts to disperse the diluted enzymatic fluid [115] or heated diluted enzymatic fluid [122] further into the oil well formation [140] to further contact oil particles [142] thereby increasing contact volume.

The heat available to be transferred to the oil well formation [140] and oil particles [142] reacts over a period of time while the well sits idle. The soak stage [30] as it is known, allows the heat to permeate the oil well formation [140] and the diluted enzymatic fluid [115] or heated diluted enzymatic fluid [122] to reach maximum oil releasing efficiency. The diluted enzymatic fluid [115] or heated diluted enzymatic fluid [122] remains active in water or hot water included condensed steam [147] and acts catalytically in contacting and releasing oil from solid surfaces. The soak stage [30] lasts between 3-5 to 30 days depending on the type and size of the oil well formation [140].

Following the soak stage [30] is the recovery stage [40] in which an extraction pump [160] is connected to the oil well formation [140] via a retrieval pipe [165] and an uphole well bore [170]. In the recovery stage [40], the extraction pump [160] is activated causing the oil particles [142] to be transferred from the oil well formation [140] through the uphole well bore [170] and retrieval pipe [165] to be transferred for refining.

We claim:

1. An enzymatic fluid for enhanced recovery of oil or other hydrocarbon deposits in a subterranean formation, wherein said deposits are releasable by initially adding said enzymatic fluid directly to a pump for pumping said fluid into said oil formation followed by a period of time allowing said fluid to soak said formation, followed by injection of either water or steam or both into said formation, followed by an additional period of time allowing water, steam, and enzymatic fluid to soak within said formation, followed by recovery of said deposits by pumping or other means.

2. The enzymatic fluid of claim 1, wherein the enzyme fluid is a stabilized aqueous enzyme fluid made thru batch fermentation and wherein said deposits include crude oil.

3. The enzymatic fluid of claim 1, wherein the method for injecting said enzymatic fluid includes a process referred to as cyclic steam stimulation (CSS).

4. The enzymatic fluid of claim 1, wherein said fluid is used for pre-treatment and treatment between steam injection cycles or treatment of the subterranean formation during a steam injection cycle wherein said enzymatic fluid is injected as a heated liquid into said formation.

5. The enzymatic fluid of claim 1, wherein said enzymatic fluid is heated before injection into a well thereby minimizing heat loss downhole and allowing maximize penetration of injected steam.

6. The enzymatic fluid of claim 1, wherein said fluid is diluted with water to a working range of 0.5 to 10% percent enzymatic fluid in water prior to pumping downhole.

7. The enzymatic fluid of claim 1, wherein said fluid is used for pre-treatment or treatment of said formation during enhanced oil recovery such that said fluid is injected and intermixed with water which is sent into said formation and wherein said formation is a well that is subsequently not used for a period of time allowing for soaking of said well prior to another phase of enhanced oil recovery including, but not limited to pumping and use of steam for one or more cycles during said recovery.

8. The enzymatic fluid of claim 1, wherein said fluid reduces asphaltenes and waxes at an injection wellbore prior to steam injection as well as minimizing wellbore build up during production that occurs at an end of an enhanced oil recovery cycle, wherein said cycle includes a cyclic steam cycle.

9. The enzymatic fluid of claim 1, wherein said enzymatic fluid is introduced into cyclic steam operations so that reduction of steamload is accomplished to impart a favorable impact to the steam-to-oil ratio thereby increasing crude oil recovery from a new or existing formation.

10. The enzymatic fluid of claim 1, wherein said enzymatic fluid, is introduced into cyclic steam operations so that the same steamload as otherwise would be used during enhanced oil recovery imparts a favorable impact to the steam-to-oil ratio, thereby increasing crude oil recovery from a new or existing formation.

11. A method for enhanced recovery of oil or other hydrocarbon deposits in a subterranean formation using an enzymatic fluid, wherein said deposits are releasable by initially adding said enzymatic fluid directly to a pump for pumping said fluid into said oil formation followed by a period of time allowing said fluid to soak said formation, next injecting either water or steam or both into said formation, next allowing an additional period of time for soaking by water, steam, and enzymatic fluid within said formation, followed by recovery of said deposits by pumping or other means.

12. The method of claim 11, wherein said fluid is initially diluted or heated or both prior to adding said fluid to said formation.

13. The method of claim 11, wherein adding said fluid after initial steam injection or cycling of said steam is accomplished.

14. The method of claim 11, wherein the method for injecting said enzymatic fluid includes a process referred to as cyclic steam stimulation (CSS).

15. The method of claim 11, wherein using said fluid for pre-treatment and treatment between steam injection cycles or treatment of said subterranean formation during a steam injection cycle wherein said enzymatic fluid is injected as a heated liquid into said formation, is accomplished.

16. The method of claim 11, wherein diluting said fluid with water in a working range of 0.5 to 10 percent of said enzymatic fluid in water.

17. The method of claim 11, wherein using said fluid for pre-treatment or treatment of said formation during enhanced oil recovery such that injecting said fluid and intermixing with water is accomplished and said fluid and water are sent into said formation and wherein said formation is a well that is subsequently not used for a period of time allowing for soaking of said well prior to another phase of enhanced oil recovery including, but not limited to pumping and using steam for one or more cycles during said recovery.

18. The method of claim 11, wherein said fluid provides a means for reducing asphaltenes and waxes at an injection wellbore prior to steam injection as well as minimizing wellbore build up during production occurring at an end of an enhanced oil recovery cycle, wherein said cycle includes a cyclic steam cycle.

19. The method of claim 11, wherein introducing said stabilized enzymatic fluid into cyclic steam operations reduces steamload to impart a favorable impact to the steam-to-oil ratio thereby increasing crude oil recovery from a new or existing formation.

20. The method of claim 11, wherein introducing said stabilized enzymatic fluid into cyclic steam operations so that the same steamload as otherwise would be used during enhanced oil recovery imparts a favorable impact to the steam-to-oil ratio, thereby increasing crude oil recovery from a new or existing formation.

21. A system for enhanced recovery of oil or other hydrocarbon deposits in a subterranean formation using an enzymatic fluid, wherein said deposits are releasable by initially adding said enzymatic fluid directly to a pump for pumping said fluid into said oil formation followed by a period of time allowing said fluid to soak said formation, next injecting either water or steam or both into said formation, next allowing an additional period of time for soaking by water, steam, and enzymatic fluid within said formation, followed by recovery of said deposits by pumping or other means and wherein said fluid is initially diluted or heated or both prior to adding said fluid to said formation, and wherein adding said fluid after initial steam injection or cycling of said steam is accomplished.
